(19) United States
(12) Patent Application Publication
(10) Pub. No.: US 2014/0375947 A1
(43) Pub. Date: Dec. 25, 2014

(54) HEADSET WITH COMFORT FIT TEMPLE ARMS

(71) Applicants: Joseph Juseop Park, Bellevue, WA (US); Jeffrey Heinz, Redmond, WA (US); Ichiro Yamada, Redmond, WA (US); Paul M. O'Brien, Sammamish, WA (US)

(72) Inventors: Joseph Juseop Park, Bellevue, WA (US); Jeffrey Heinz, Redmond, WA (US); Ichiro Yamada, Redmond, WA (US); Paul M. O'Brien, Sammamish, WA (US)

(21) Appl. No.: 13/925,611

(22) Filed: Jun. 24, 2013

(51) Int. Cl. G02C 5/16; G02C 13/00

(52) U.S. Cl. CPC G02C 5/16; G02C 13/001
USPC 351/113; 351/178

(57) ABSTRACT

AN HMD is disclosed including a pair of temple arms which wrap around a portion of a user's head. The temple arms provide long axis (front to back) compression, and compression against sides of the user's head. Such a distribution of forces prevents resting of the HMD primarily on the nose, ears or the top of the head, and allows the HMD to be worn in a way that is comfortable and non-intrusive.

### BACKGROUND

A near-eye display device, such as a head mounted display (HMD), may be worn by a user for an augmented reality experience or a virtual reality experience. A typical HMD may have a small optic or display in front of one eye (monocular HMD) or both eyes (binocular HMD). In a virtual reality experience, a display may provide a computer-generated image (CGI) to a user wearing an HMD. In an augmented reality experience, a display may use an optical see-through lens to allow a CGI to be superimposed on a real-world view. A display in an HMD may include a helmet, visor, glasses, goggles or attached by one or more straps. HMDs are used in at least aviation, engineering, science, medicine, gaming, video, sports, training and simulations.

### SUMMARY

The present technology relates to various embodiments of an HMD having a pair of temple arms which wrap around a portion of a user's head. The temple arms provide long axis (front to back) compression, and compression against sides of the user's head. Such a distribution of forces prevents resting of the HMD primarily on the nose, ears or the top of the head, and allows the HMD to be worn in a way that is comfortable and non-intrusive.

In a first embodiment of the HMD, each temple arm includes a flexing spring member that flexes to bend the temple arm around a user's head. In a second embodiment, each temple arm is formed of multiple spring joints which wrap the temple arm around the user's head. In a third embodiment, each temple arm is formed of two layers of flexible materials affixed to each other along their lengths. By shortening a length of one layer with respect to the other, the temple arm bends around the user's head.

In one example, the present technology relates to a temple arm for a head mounted display, the temple arm including a first end proximal optics for the head mounted display and a second end opposite the first end, the arm comprising: a band extending at least partially between the first and second ends; a spring extending at least partially between the first and second ends, the spring and band affixed together at the first and second ends and the spring being longer than the band and flexed away from the band in one of a first direction and a second direction, the band being substantially straight when the spring is flexed into the first direction, and the band bending when the spring is flexed into the second direction.

In another example, the present technology relates to a temple arm for a head mounted display, the temple arm including a first end proximal optics for the head mounted display and a second end opposite the first end, the arm comprising: a plurality of arm sections; and a plurality of spring joints between and affixing the arm sections, a spring joint including a spring and one or more fasteners for affixing the spring joint between adjacent arm sections of the plurality of arm sections, the spring biasing the adjacent arm sections to fold toward each other, the adjacent arm sections including ends which come together to limit folding of the adjacent arm sections with respect to each other.

In a further example, the present technology relates to a method of a method of supporting a head mounted display on a head of a wearer, the head mounted display including optics, the method comprising: (a) configuring a pair of temple arms affixed to the optics to maintain a first shape enabling the temple arms to be positioned on opposite temples of a wearer; (b) configuring the pair of temple arms to maintain a second shape where each temple arm includes at least a portion distal from the optics that wrap partially around a head of the wearer; and (c) providing a mechanism for moving the pair of temple arms from the first shape to the second shape when the head mounted display is worn by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a side view of a temple arm used in an HMD according to a first embodiment of the present technology.

FIG. 2 is a top view of a pair of temple arms used in an HMD according to a first embodiment of the present technology.

FIGS. 3-5 are various perspective views a temple arm used in an HMD according to a first embodiment of the present technology.

FIGS. 6 and 7 are top views of a pair of temple arms according to a first embodiment of the present technology in an open position.

FIGS. 8 and 9 are top views of a pair of temple arms according to a first embodiment of the present technology in bent position.

FIG. 10 is a side view of a temple arm used in an HMD according to a second embodiment of the present technology.

FIG. 11 is a top view of a pair of temple arms used in an HMD according to a second embodiment of the present technology.

FIG. 12 is a perspective view a temple arm used in an HMD according to a second embodiment of the present technology.

FIGS. 13 and 14 are top views of adjacent arm sections and spring joint in closed and open positions, respectively.

FIG. 15 shows an HMD with temple arms in bent positions and a head of the user to show comparison of relative sizes.

FIG. 16 shows an HMD with temple arms wrapped around a head of the user.

FIG. 17 is a side view of a temple arm used in an HMD according to a third embodiment of the present technology.

FIG. 18 is a top view of a pair of temple arms used in an HMD according to a third embodiment of the present technology.

FIG. 19 is a top view a temple arm of the third embodiment in a straight position.

FIG. 20 is a top view a temple arm of the third embodiment in a bent position.

FIG. 21 is a top view of an HMD including temple arms of the third embodiment in a straight position.

FIG. 22 is a top view of an HMD including temple arms of the third embodiment in a bent position wrapped around a user's head.

FIG. 23A is a block diagram depicting example components of an embodiment of a personal audiovisual (AV) apparatus having a near-eye augmented reality display and companion processing module.

FIG. 23B is a block diagram depicting example components of another embodiment of a AV apparatus having a near-eye augmented reality display.

FIG. 24A is a side view of an HMD having a temple arm with a near-eye, optical see-through augmented reality display and other electronics components.

FIG. 24B is a top partial view of an HMD having a temple arm with a near-eye, optical see-through, augmented reality display and other electronic components.

FIG. 25 illustrates is a block diagram of a system from a software perspective for representing a physical location at a previous time period with three dimensional (3D) virtual data being provided by a near-eye, optical see-through, augmented reality display of a AV apparatus.

FIG. 26 illustrates is a block diagram of one embodiment of a computing system that can be used to implement a network accessible computing system or a companion processing module.

### DETAILED DESCRIPTION

Embodiments of the present technology will now be explained with reference to the figures, which in general relate to a variety of different temple arms for an HMD that provide a comfortable and non-intrusive fit. In embodiments, the temple arms provide long axis (front to back) compression, and compression against sides of the user's head. Such a distribution of forces provides comfort, in part by preventing the HMD from resting primarily on the nose, ears or the top of the head.

In embodiments described below, the temple arms are used in an HMD for providing a virtual and/or augmented reality experience. However, in alternate embodiments, the pair of temple arms maybe used to mount other head mounted devices, such as surgical loupes, high-power headlamps and other types of head mounted devices.

In a first embodiment, each temple arm includes a flexing spring member that flexes to bend the temple arm around a user's head. In a second embodiment, each temple arm is formed of multiple spring joints which wrap the temple arm around the user's head. In a third embodiment, each temple arm is formed of two layers of flexible materials affixed to each other along their lengths. By shortening a length of one layer with respect to the other, the temple arm bends around the user's head. Each of these embodiments is described in greater detail below.

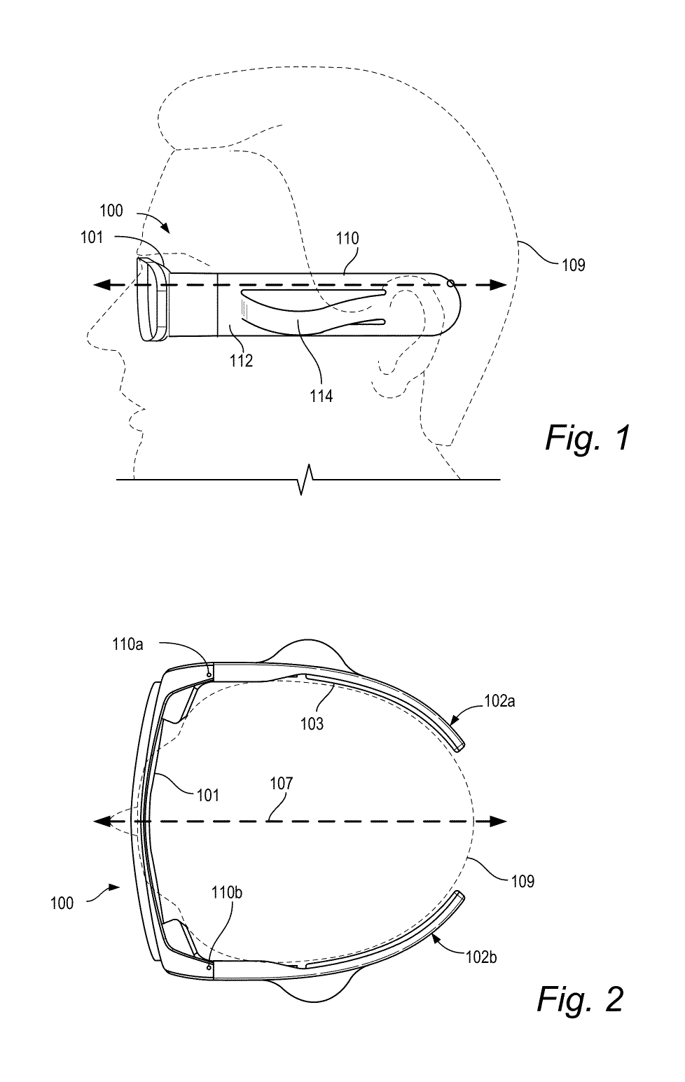

FIGS. 1 and 2 are side and top views of an HMD 100 according to a first embodiment having a pair of temple arms 102 comprised of temple arm 102a and temple arm 102b. The pair of temple arms 102a-b wrap at least partially around a user's head 109 to provide a long axis compression that comfortably secures a weight at a forehead of the user. In particular, temple arms 102 produce a compressive force toward the long axis 107 of a user's head 109 (front to back) that counters a gravitational (downward) force of the weight of the HMD 100 at the forehead. Temple arms 102a-b also exert a clamping or compression force inward against sides of the head 109 as the pair of temple arms 102a-b wrap around the head 109. Weight at the forehead is supported primarily by the long axis compression, rather than resting on the nose, ears or the top of the head. The weight at the forehead may include at least the weight of a display optical system as well as other electronic components. In embodiments, the display optical system may be used in an augmented or virtual reality experience as described herein.

In an embodiment, temple arms 102a-b are coupled to display optical system 101 by articulating hinges 110a-b. Further details of an example of display optical system 101 are explained below. Hinges 110a-b allow the temple arms to fold inward as in typical glasses or spectacles. In an embodiment, articulating hinges 110a-b are spring loaded hinges having a hard stop. In an embodiment, articulating hinges 110a-b will not rotate outwards until a force exceeds a predetermined spring force in articulating hinges 110a-b and the spring force of the articulating hinges 110a-b increases slightly as the temple arms 102a-b are rotated outward. In an alternate embodiment, temple arms 102a-b are coupled to display optical system 101 without articulating hinges 110a-b and thus temple arms 102a-b cannot be folded inward.

An interface material 103 is formed on or around temple arms 202a-b to provide comfort to a user's head 109. Material 103 may for example be or include polyurethane, a polyurethane foam, rubber or a plastic or other polymer. The interface material 103 may alternatively be or include fibers or fabric. Other materials are contemplated.

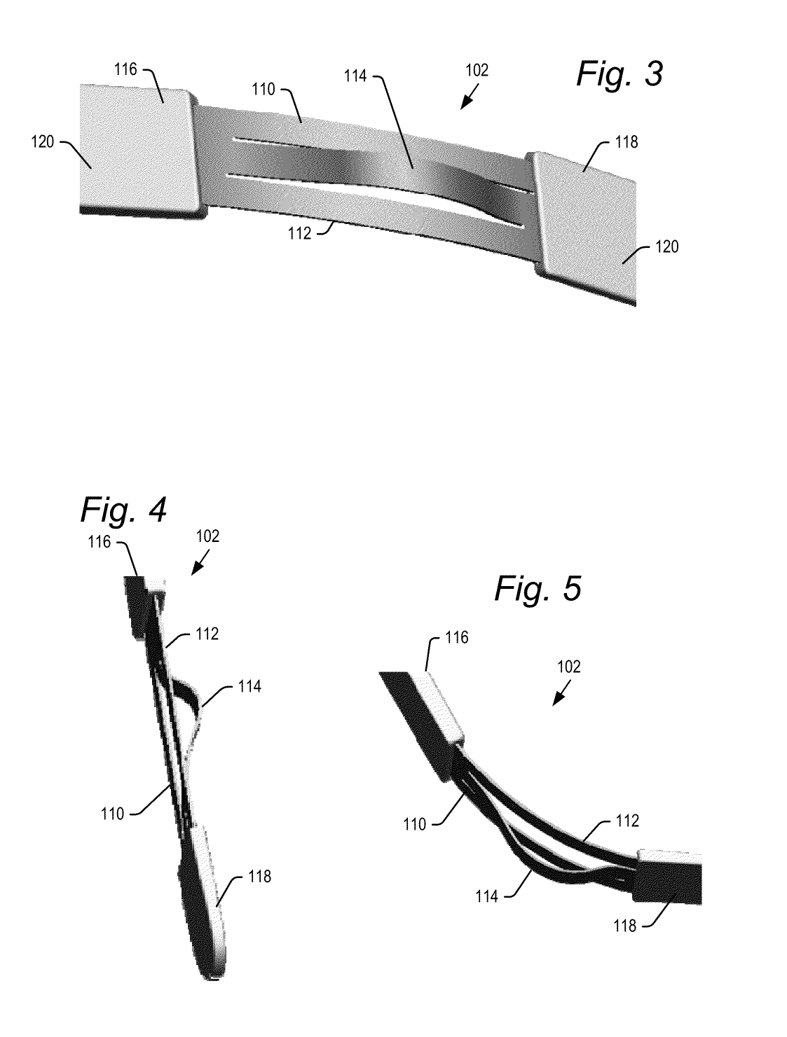

Further details of temple arms 102 are now described with reference to FIGS. 1-5. FIGS. 3-5 show one of the temple arms 102. The arms 102a-b may be identical mirror images of each other and the following description applies to both arms 102a-b. Temple arm 102 includes metal bands 110 and 112 on either side of a metal plate spring 114. Each of the bands 110, 112 and plate spring 114 are affixed to each other at opposed ends 116, 118.

The ends 116, 118 may be encased within a soft material 120, which may be interface material 103, or a similar material to interface material 103. Although not shown in the figures, the soft material may lie on one side of the bands 110, 112 and spring 114, or may encase the bands 110, 112 and spring 114. The soft material may extend over a partial length or the entire length of bands 110, 112 and spring 114.

The bands 110, 112 and spring 114 may be formed of the same material, which may be stainless steel or titanium in embodiments of the present technology. It is understood that the bands 110, 112 and spring 114 may be formed of other materials in further embodiments. In one example, there is one band on either side of the plate spring 114, each separated from each other by an elongate gap between the metal bands and spring. In further embodiments, it is conceivable that there be one band 110/112 and two springs 114 which operate as described below, with the band positioned between the springs. In a further embodiment, there may be other numbers of bands and/or springs, each separated by an elongate gap.

The plate spring 114 is longer than the bands 110, 112, and is preloaded and flexed, either extending inward toward a user's head (FIGS. 4, 6 and 7) or outward away from a user's head 109 (FIGS. 1, 2, 5, 8 and 9). The metal bands 110, 112 are also preloaded with forces which oppose those in spring 114 in such a way that temple arm 102 has two equilibrium states. When the metal spring 114 is flexed (bent) inward, the forces in bands 110, 112 are generally equal and opposite to the force in spring 114 when the bands 110, 112 have a generally straight shape as shown in FIGS. 4, 6 and 7.

On the other hand, when metal spring 114 is flexed outward, the forces in the bands 110, 112 are generally equal and opposite to the force in spring 114 when the bands 110, 112 are curved inward toward the user's head 109 as shown in FIGS. 1, 2, 5, 8 and 9. When wrapped around a user's head 109, the temple arms 102 may exert a pressure on the sides of the user's head and rear portions of a user's head, along long axis 107. Thus, the temple arms 102 effectively secure the HMD 100 to the user's head in a comfortable manner, reducing excessive forces in the user's ears and/or nose bridge otherwise found in conventional HMDs.

The degree of curvature may be controllably varied by varying the spring constant in spring 114 and the opposing forces in spring 114 and bands 110, 112. The degree of curvature may also be controllably varied by varying the length of spring 114 relative to the length of bands 110, 112.

For example, increasing the length of spring 114 and/or force with which spring 114 is preloaded will increase the amount by which temple arm 102 curves when the spring 114 is flexed outward. Thus, temple arms 102 may be adapted for users having different sized heads 109.

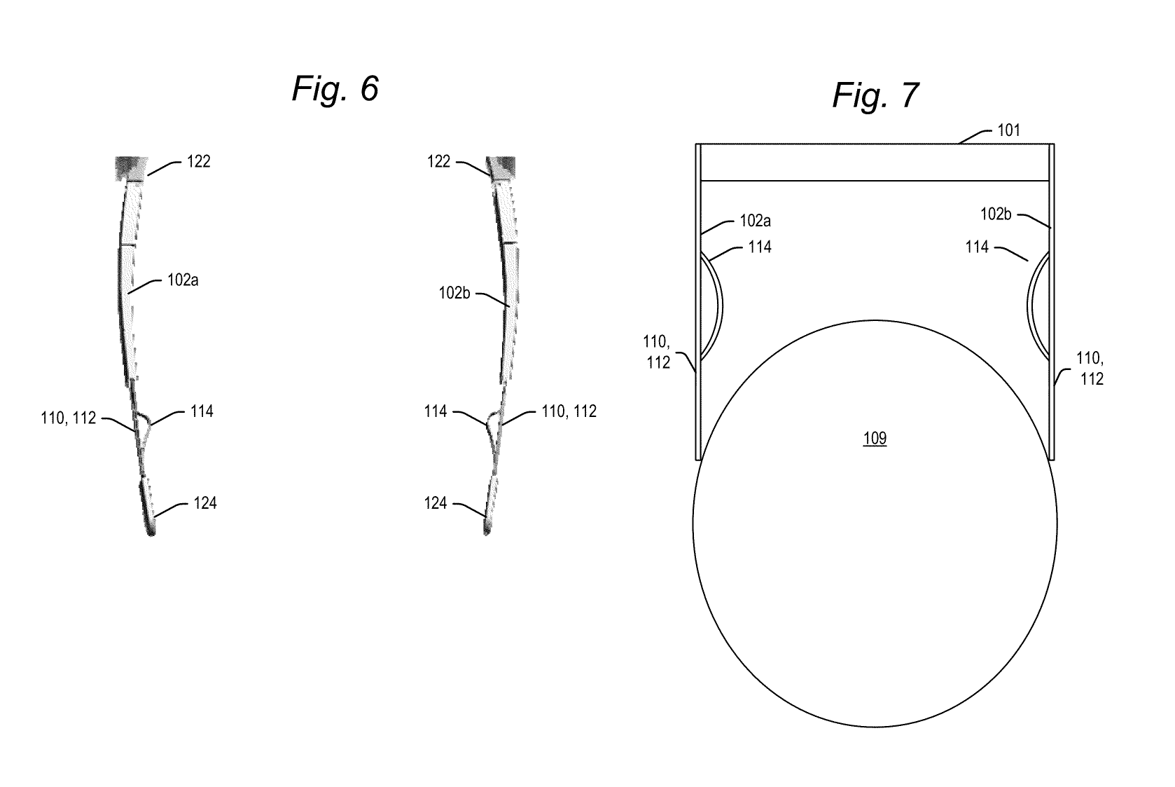

Referring now to FIGS. 6-9, temple arms 102a-b may have a proximal end 122 nearest display optical system 101 and hinges 110, and a distal end 124 opposite the proximal end 122. In one embodiment (shown in the figures), spring 114 is located near the proximal end 124. When not on a user's head 109, the temple arms 102a-b may be straight with the spring 114 flexed inward.

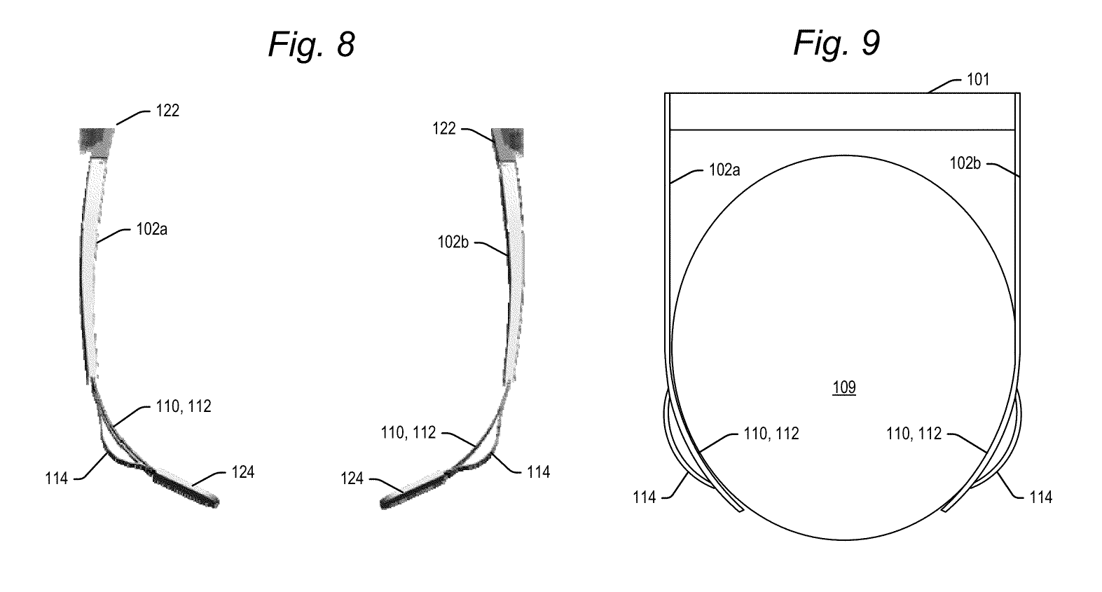

As a user puts the HMD 100 on their head 109, the spring 114 may engage the temples of the user's head 109. This engagement may be sufficient to bias the spring 114 into its outward position, resulting in the inward bending of the distal ends 124 of temple arms 102 as shown in FIGS. 8 and 9. In this way, using a single hand, the HMD 100 may be placed on a user's head 109, and flipped to the secure position where temple arms 102 wrap around a user's head.

In further embodiments, the spring 114 may be located near the distal end 122 of temple arms 102. The effect of this modification is to change the point at which the spring 114 flips from its inward position to its outward position, and the point at which temple arms bend around head 109, as a user is putting on the HMD 100. It is further understood that the spring 114 may be located anywhere between proximal end 122 and distal end 124.

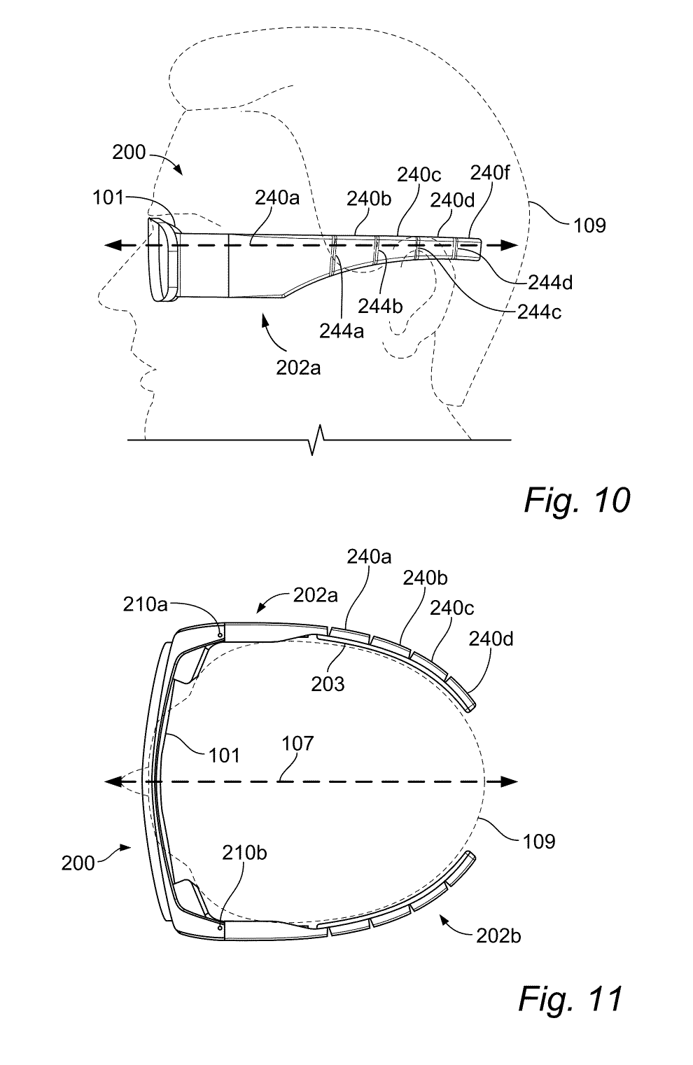

FIGS. 10-16 illustrate a further embodiment of the present technology including an HMD 200 having temple arms 202 comprised of arms 202a and 202b. The pair of temple arms 202a-b wrap around head 109 to provide a long axis compression that comfortably secures a weight at a forehead of a user. In particular, temple arms 202 produce a compressive force toward the long axis 107 of a user's head 109 (front to back) that counters a gravitational (downward) force of the weight of the HMD 200 at the forehead. Temple arms 202a-b also exert a clamping or compression force inward against the head 109 as the pair of temple arms 202a-b wrap around the head 109. Weight at the forehead is supported primarily by the long axis compression, rather than resting on the nose, ears or the top of the head. The weight at the forehead may include at least the weight of a display optical system as well as other electronic components. In embodiments, the display optical system may be used in an augmented or virtual reality experience as described herein.

In an embodiment, temple arms 202a-b are coupled to display optical system 101 by articulating hinges 210a-b, which are structurally and operationally similar to hinges 110a-b described above. An interface material 203 is formed internally to temple arms 202a-b to provide comfort to a user's head 109. Material 203 may for example be polyurethane, a polyurethane foam, rubber or a plastic or other polymer. Other materials are contemplated.

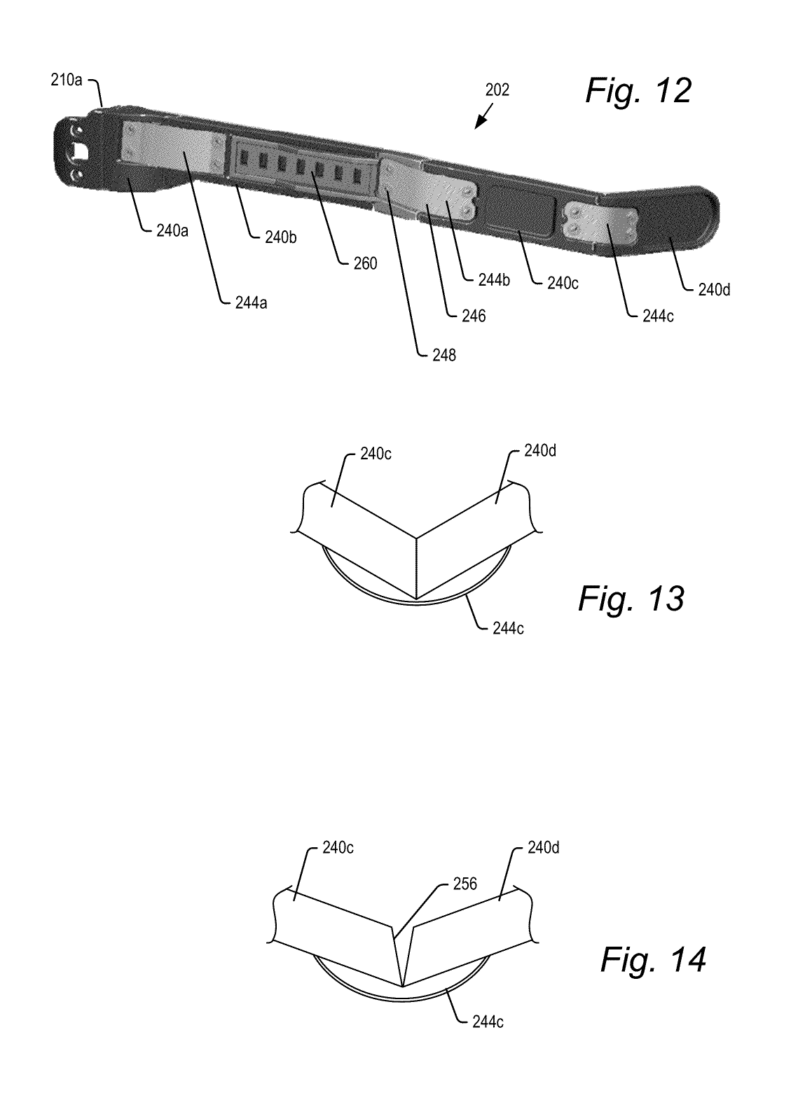

Further details of temple arms 202 are now described with reference to FIGS. 10-16. FIG. 12 shows one of the temple arms 202. The arms 202a-b may be identical mirror images of each other and the following description applies to both arms 202a-b. Temple arm 202 may have multiple, rigid arm sections 240a, b . . . , n (collectively referred as arm sections 240). Each arm section 240 may be affixed by a spring joint 244a, b . . . , n−1 (collectively referred to as spring joints 244).

Each spring joint 244 may include a plate spring 246, and fasteners 248, as shown for example on spring joint 244b. Fasteners 248 (one of which is labeled on spring joint 244b) fasten the plate spring 246 between adjacent arm sections 240. The fasteners may for example be rivets, though other fasteners may be used in further embodiments.

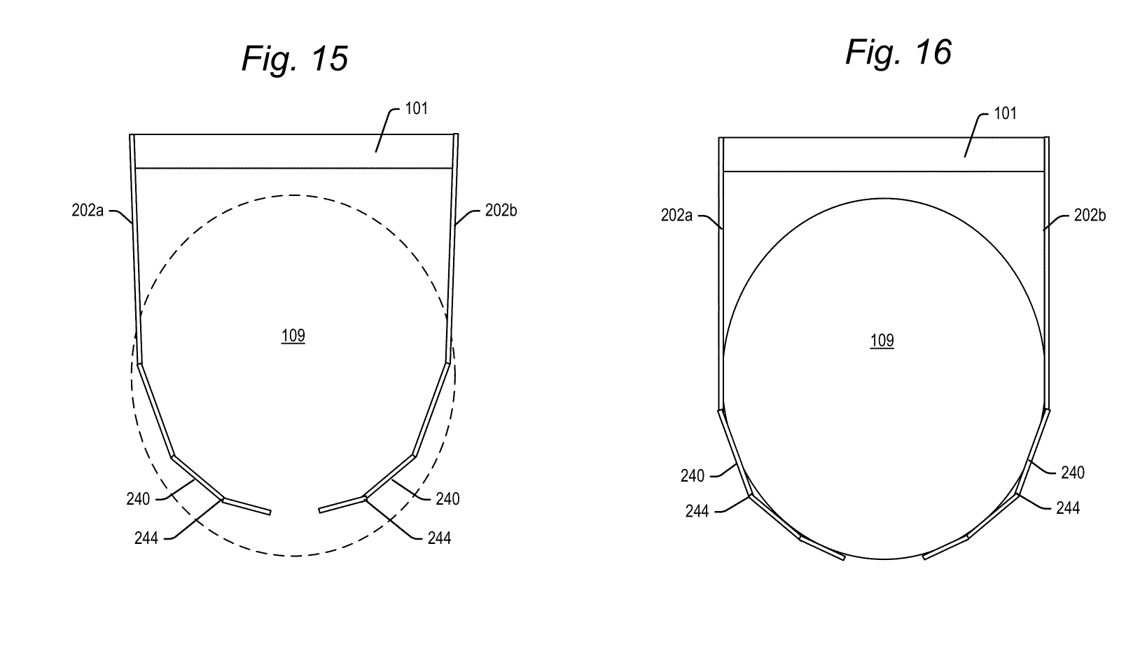

When not worn on a user's head 109, the plate springs 246 of spring joints 244 bias the temple arms 202 into bent positions so that temple arms 202 together may be smaller than a user's head 109, as shown in FIG. 15. In particular, each plate spring 246 is preloaded into a flexed (bent) position so as to bias the adjacent arm sections 240 into a folded relation to each other. The ends of each arm section 240 may have a face 256, one of which is labeled in FIG. 14. The plate spring 246 in a spring joint 244 biases the adjacent arm sections 240 together until the faces 256 on the adjacent arm sections 240 abut against each other as indicated in FIG. 13. This prevents further folding of the adjacent arm sections 240 with respect to each other, and prevents coiling of the temple arms 202.

In order to put on the HMD 200, a user may grasp the temple arms 202a-b in respective hands and bend the temple arms 202 outward against the force of springs 246. This straightens adjacent arm sections 240 with respect to each other as shown in FIG. 14, and allows a user to wrap the temple arms 202a-b around their head 109 as shown in FIG. 16.

Each of the arm sections 240 may lie against the head 109 and exert a force against the head 109. These forces support the HMD 200 comfortably on the user's head, and alleviate pressure on the ears and bridge of the nose found with conventional HMD temple arms. The amount of force exerted by each arm section 240 may be controlled by setting the force with which springs 246 bias the adjacent arm sections 240 together. In particular, by setting the spring constants of the different springs 246 in the spring joints 244 to predetermined values, the forces exerted by the arm sections 240 on different portions of the head may be controlled.

For example, in one embodiment, it is desired to have relatively large forces supporting the HMD 200 toward the back of the head, i.e., along the long axis 107. By providing the springs 246 near the distal end of temple arms 202 with higher spring constants than springs 246 nearer to the proximal end of temple arms 202, larger forces may be exerted on the back of the head than on the sides. Similarly, by providing the springs 246 near the proximal end of temple arms 202 with higher spring constants than springs 246 nearer to the distal end of temple arms 202, larger forces may be exerted on the sides of the head than on at the back.

One or more of the arm sections may have adjustable lengths, such as arm section 240b shown in FIG. 12. In embodiments, the length of an arm section may be made adjustable by, for example, forming it of overlapping telescopic sections. A clasp 260 is shown in FIG. 12 allowing a user to adjust and set the length of arm section 240b. In particular, an adjustable portion of arm section 240b may include one or more tabs extending from the surface of arm section 240b. Once the length of arm section 240b is set, the one or more tabs may fit within holes in clasp 260 to fix the length of the section. Any of the other arm sections 240 may be made adjustable in this manner. It is understood that the arm sections may be made adjustable by other adjustment schemes in further embodiments.

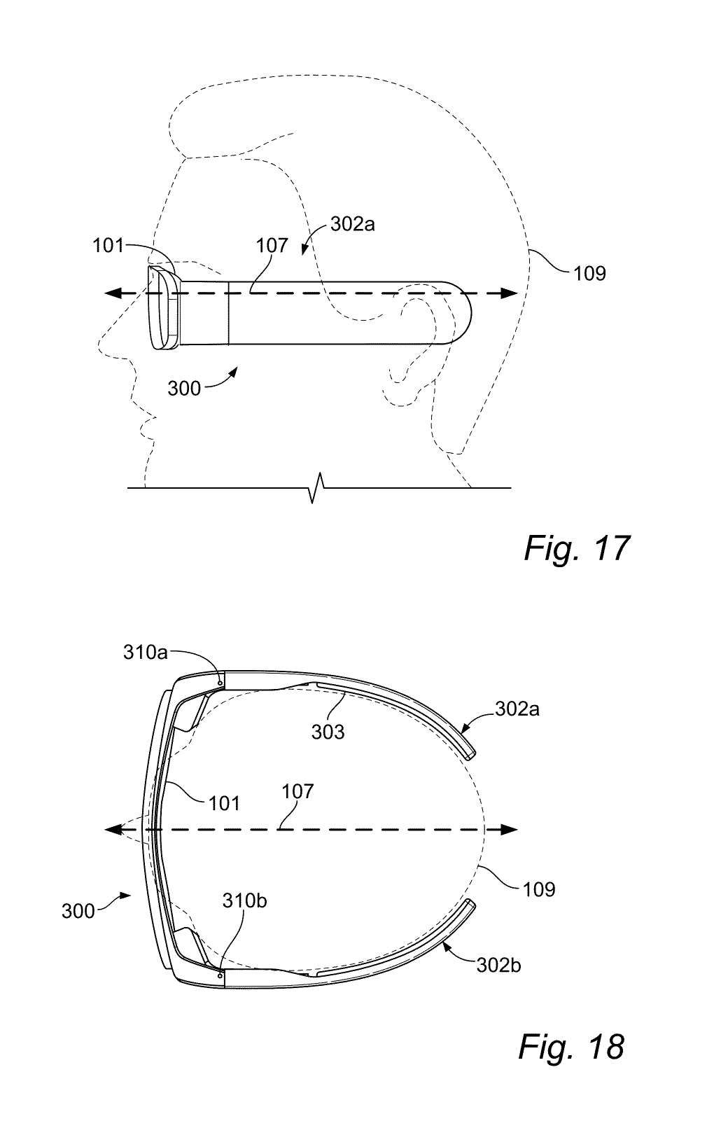

FIGS. 17-22 illustrate a further embodiment of the present technology including an HMD 300 having temple arms 302 comprised of arms 302a and 302b. The pair of temple arms 302a-b wrap around head 109 to provide a long axis compression that comfortably secures a weight at a forehead of a user. In particular, temple arms 302 produce a compressive force toward the long axis 107 of a user's head 109 (front to back) that counters a gravitational (downward) force of the weight of the HMD 300 at the forehead. Temple arms 302a-b also exert a clamping or compression force inward against the head 109 as the pair of temple arms 302a-b wrap around the head 109. Weight at the forehead is supported primarily by the long axis compression, rather than resting on the nose, ears or the top of the head. The weight at the forehead may include at least the weight of a display optical system as well as other electronic components. In embodiments, the display optical system may be used in an augmented or virtual reality experience as described herein.

In an embodiment, temple arms 302a-b are coupled to display optical system 101 by articulating hinges 310a-b, which are structurally and operationally similar to hinges 110a-b described above. An interface material 303 is formed internally to temple arms 302a-b to provide comfort to a user's head 109. Material 303 may for example be polyurethane, a polyurethane foam, rubber or a plastic or other polymer. Other materials are contemplated.

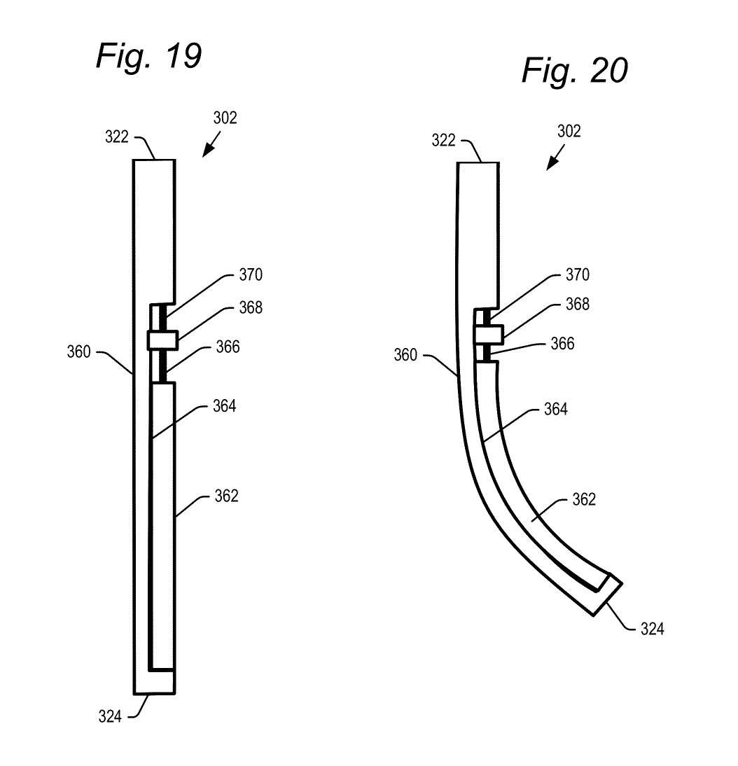

Further details of temple arms 302 are now described with reference to FIGS. 17-22. FIGS. 19 and 20 show one of the temple arms 302 with a straight shape and curved shape, respectively. The arms 302a-b may be identical mirror images of each other and the following description applies to both arms 302a-b. Arm 302 may include outer section 360 and inner section 362 which may also be referred to herein as first and second layers, respectively. The inner section 362 may be affixed to outer section 360 along an interface 364 for example as by an adhesive such as glue or epoxy. In a further embodiment, the inner and outer sections may be a single unitary construction instead of two separate sections affixed to each other.

The inner and outer sections may have a degree of flexibility so that they may be straight when unbiased, but can flex (bend) when a force is applied. Various shape memory metals, plastics and other polymers may be used for the inner and outer sections 360, 362. Other materials are contemplated.

The inner section 362 may have a cord 366 received within a wheel 368. In one example, the cord 366 is mounted to wheel 368 by bearings (not shown) within wheel 368 so that wheel 368 can rotate while the cord 366 does not. In a further example, the bearings may be provided within inner section 362, so that both the wheel 368 and cord 366 can rotate with respect to inner section 362.

A threaded screw 370 may be fixedly mounted to and protrude from a side of the wheel 368 opposite the side including cord 366. Screw 370 may extend into a threaded bore (not shown) in the outer section 360. With this configuration, rotation of the wheel 368 in first direction will rotate the screw 370 and thread the screw 370 up into the threaded bore of outer section 360, closer to a proximal end 322 of the temple arm 302. This will also move the wheel 368 and cord 366 closer to proximal end 322 of the temple arm 302.

The cord 366 may be affixed to the inner section 362 at various points along the length of inner section 362. The result of moving the cord 366 toward the proximal end of temple arm 302 is that the inner section 362 will shorten. As noted above, the inner section 362 is affixed to the outer section 360 along the interface 364. This shortening of inner section 362 will therefore result in bending of portions of the inner section 362 and outer section 360 near the distal end 324 of temple arm 302, as shown in FIG. 20.

By rotating the screw in a second direction opposite the first direction, the cord 366, wheel 368 and screw 370 move away from the proximal end 322, resulting in the shape of temple arm 302 moving from the bent position shown in FIG. 20 back to the unbiased straight position shown in FIG. 19.

In a further embodiment, the relative positions of cord 366 and screw 370 may be reversed on the wheel 368. In such an embodiment, the screw 370 may be threaded into a threaded bore in the inner section 362, and the cord 366 may be affixed to the wheel 368 or outer section 360 by bearings. Thus, rotation of the wheel 368 will thread the screw 370 into and out of the inner section 362, depending on the direction of rotation, thereby changing the shape of the temple arm 302 between that shown in FIGS. 19 and 20 as explained above.

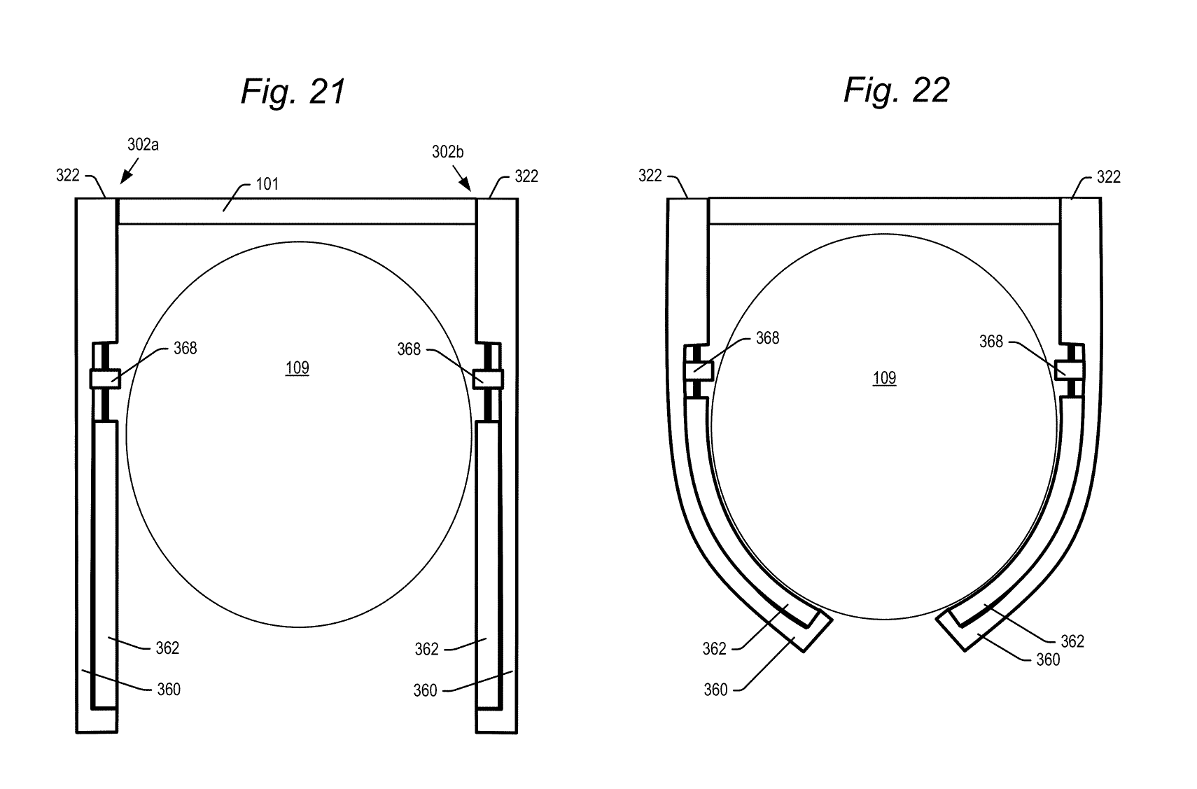

Referring now to FIGS. 21 and 22, a user may place the HMD 300 on the head 109 with the temple arms 302a-b in a straight position as shown in FIG. 21. Thereafter, a user may rotate wheels 368 to bend distal portions of the temple arms 302a-b around the user's head 109 as shown in FIG. 22. A user may control the forces exerted by the temple arms 302a-b by the degree to which the user rotates wheels 368.

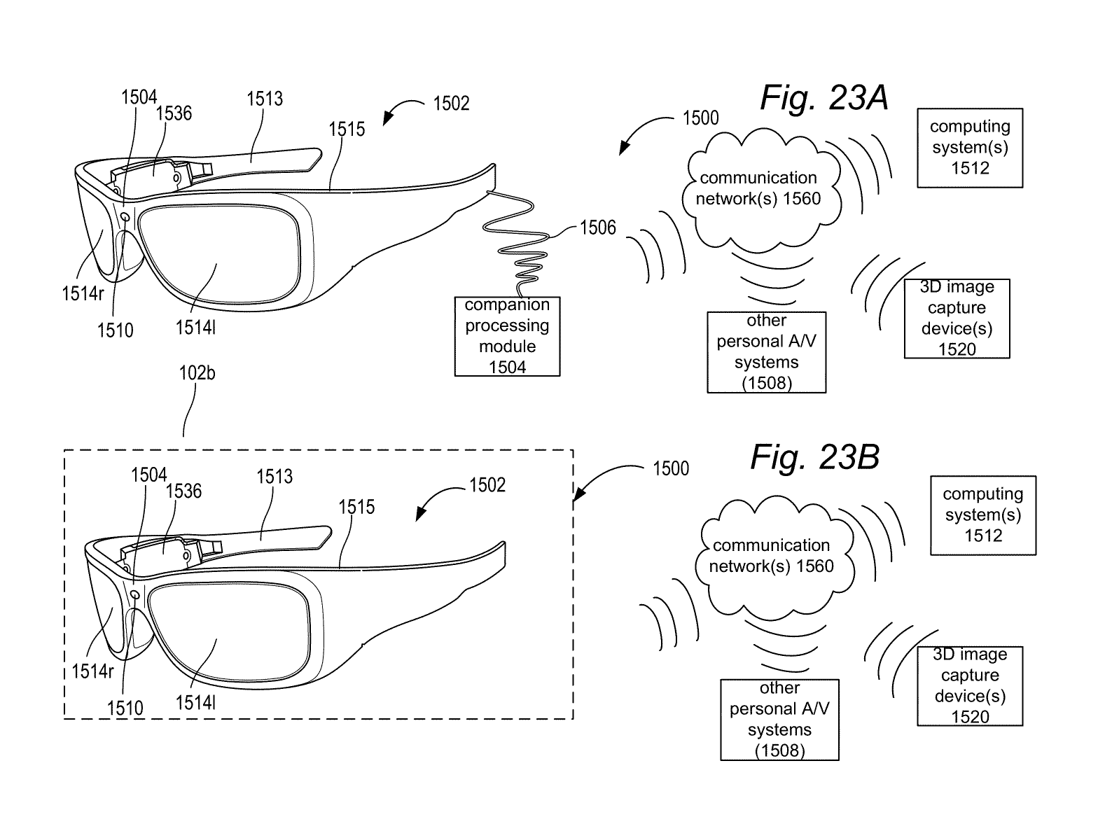

As noted above, in one example the HMDs 100, 200, 300 may be used for creating virtual and augmented reality environments. FIG. 23A is a block diagram depicting example components of a personal audiovisual (A/V) apparatus 1500 including a virtual or augmented reality HMD 1502 having temple arms as described herein. Personal A/V apparatus 1500 includes an optical see-through, augmented reality display device as a near-eye, augmented reality display device or HMD 1502 in communication with a companion processing module 1504 via a wire 1506 in this example or wirelessly in other examples. In this embodiment, HMD 1502 is in the shape of eyeglasses having a frame 1515 with temple arms as described herein, with a display optical system 1514, 1514r and 1514l, for each eye in which image data is projected into a user's eye to generate a display of the image data while a user also sees through the display optical systems 1514 for an actual direct view of the real world.

Each display optical system 1514 is also referred to as a see-through display, and the two display optical systems 1514 together may also be referred to as a see-through, meaning optical see-through, augmented reality display 1514.

Frame 1515 provides a support structure for holding elements of the apparatus in place as well as a conduit for electrical connections. In this embodiment, frame 1515 provides a convenient eyeglass frame as support for the elements of the apparatus discussed further below. The frame 1515 includes a nose bridge 1504 with a microphone 1510 for recording sounds and transmitting audio data to control circuitry 1536. A temple arm 1513 of the frame provides a compression force towards the long axis of a user's head, and in this example the temple arm 1513 is illustrated as including control circuitry 1536 for the HMD 1502.

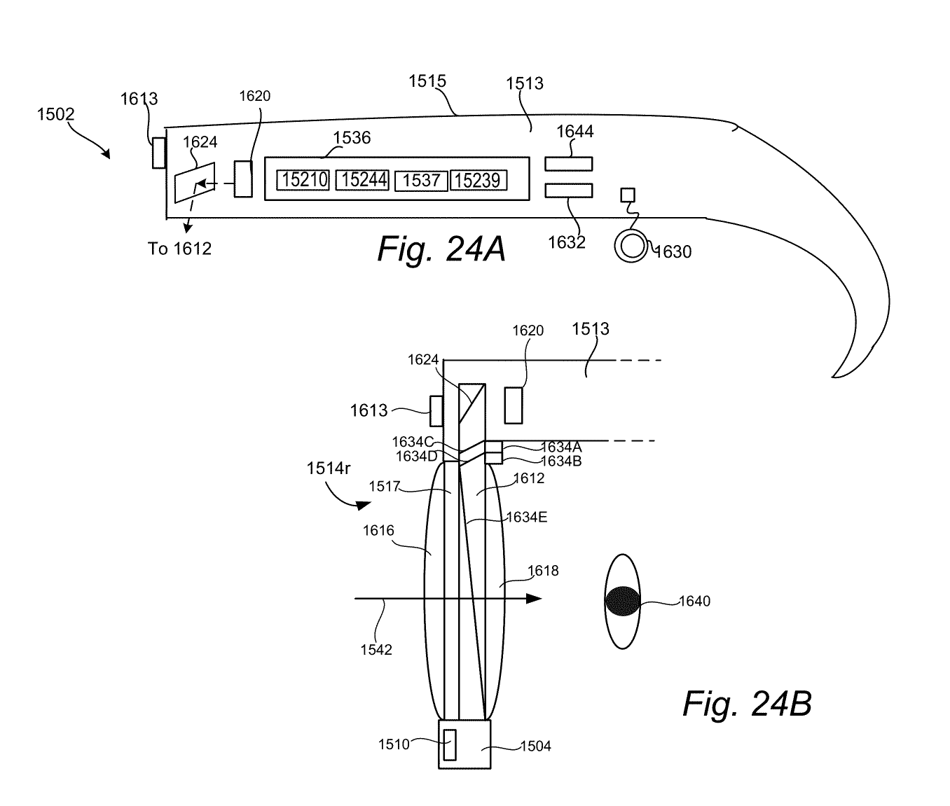

As illustrated in FIGS. 24A and 24B, an image generation unit 1620 is included on each temple arm 1513 in this embodiment as well. Also illustrated in FIGS. 24A and 24B are outward facing capture devices 1613, e.g. cameras, for recording digital image data such as still images, videos or both, and transmitting the visual recordings to the control circuitry 1536 which may in turn send the captured image data to the companion processing module 1504 which may also send the data to one or more computer systems 1512 or to another personal A/V apparatus over one or more communication networks 1560.

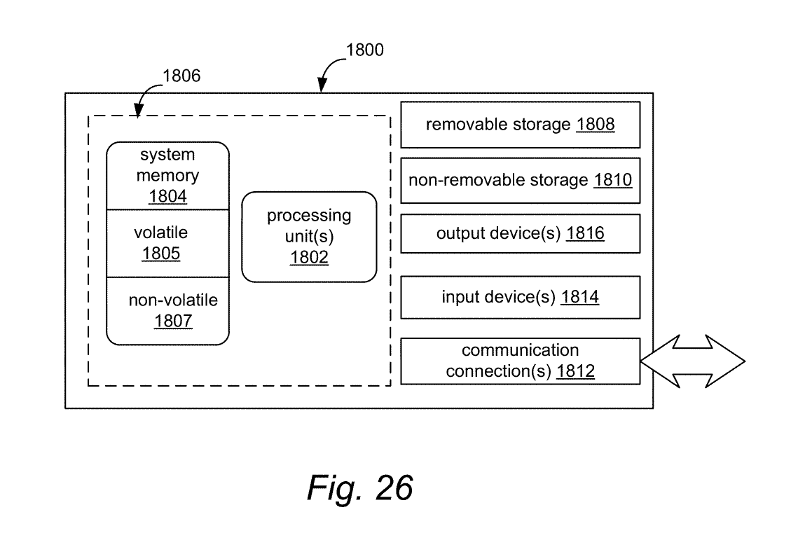

The companion processing module 1504 may take various embodiments. In some embodiments, companion processing module 1504 is a separate unit which may be worn on the user's body, e.g. a wrist, or be a separate device like a mobile device (e.g. smartphone). The companion processing module 1504 may communicate wired or wirelessly (e.g., WiFi, Bluetooth, infrared, an infrared personal area network, RFID transmission, wireless Universal Serial Bus (WUSB), cellular, 3G, 4G or other wireless communication means) over one or more communication networks 1560 to one or more computer systems 1512 whether located nearby or at a remote location, other personal A/V apparatus 1508 in a location or environment. In other embodiments, the functionality of the companion processing module 1504 may be integrated in software and hardware components of the HMD 1502 as in FIG. 23B. Some examples of hardware components of the companion processing module 1504 are shown in FIG. 26. An example of hardware components of a computer system 1512 is also shown in FIG. 26. The scale and number of components may vary considerably for different embodiments of the computer system 1512 and the companion processing module 1504.

An application may be executing on a computer system 1512 which interacts with or performs processing for an application executing on one or more processors in the personal A/V apparatus 1500. For example, a 3D mapping application may be executing on one or more computers systems and the user's personal A/V apparatus 1500.

In the illustrated embodiments of FIGS. 23A and 23B, the one or more computer system 1512 and the personal A/V apparatus 1500 also have network access to one or more 3D image capture devices 1520 which may be, for example one or more cameras that visually monitor one or more users and the surrounding space such that gestures and movements performed by the one or more users, as well as the structure of the surrounding space including surfaces and objects, may be captured, analyzed, and tracked. Image data, and depth data if captured, of the one or more 3D capture devices 1520 may supplement data captured by one or more capture devices 1613 on the near-eye, augmented reality HMD 1502 of the personal A/V apparatus 1500 and other personal A/V apparatus 1508 in a location for 3D mapping, gesture recognition, object recognition, resource tracking, and other functions as discussed further below.

FIG. 23B is a block diagram depicting example components of another embodiment of a personal audiovisual (A/V) apparatus having a near-eye augmented reality display which may communicate over a communication network 1560 with other devices. In this embodiment, the control circuitry 1536 of the HMD 1502 incorporates the functionality which a companion processing module 1504 provides in FIG. 23A and communicates wirelessly via a wireless transceiver (see wireless interface 1537 in FIG. 24A) over a communication network 1560 to one or more computer systems 1512 whether located nearby or at a remote location, other personal A/V apparatus 1500 in a location or environment and, if available, a 3D image capture device in the environment.

FIG. 24A is a side view of an eyeglass temple arm 1513 of a frame in an embodiment of the personal audiovisual (A/V) apparatus having an optical see-through, augmented reality display embodied as eyeglasses providing support for hardware and software components. At the front of frame 1515 is depicted one of at least two physical environment facing capture devices 1613, e.g. cameras, that can capture image data like video and still images, typically in color, of the real world to map real objects in the display field of view of the see-through display, and hence, in the field of view of the user. In some examples, the capture devices 1613 may also be depth sensitive, for example, they may be depth sensitive cameras which transmit and detect infrared light from which depth data may be determined.

Control circuitry 1536 provide various electronics that support the other components of HMD 1502. In this example, the right temple arm 1513 includes control circuitry 1536 for HMD 1502 which includes a processing unit 15210, a memory 15244 accessible to the processing unit 15210 for storing processor readable instructions and data, a wireless interface 1537 communicatively coupled to the processing unit 15210, and a power supply 15239 providing power for the components of the control circuitry 1536 and the other components of HMD 1502 like the cameras 1613, the microphone 1510 and the sensor units discussed below. The processing unit 15210 may comprise one or more processors including a central processing unit (CPU) and a graphics processing unit (GPU).

Inside or mounted to the temple arm of HMD 1502 is an earphone or a set of earphones 1630, an inertial sensing unit 1632 including one or more inertial sensors, and a location sensing unit 1644 including one or more location or proximity sensors, some examples of which are a GPS transceiver, an infrared (IR) transceiver, or a radio frequency transceiver for processing RFID data.

In this embodiment, each of the devices processing an analog signal in its operation include control circuitry which interfaces digitally with the digital processing unit 15210 and memory 15244 and which produces or converts analog signals, or both produces and converts analog signals, for its respective device. Some examples of devices which process analog signals are the sensing units 1644, 1632, and earphones 1630 as well as the microphone 1510, capture devices 1613 and a respective IR illuminator 1634A, and a respective IR sensor or camera 1634B for each eye's display optical system 154l, 154r discussed below.

Mounted to or inside temple arm 1513 is an image source or image generation unit 1620 which produces visible light representing images. The image generation unit 1620 can display a virtual object to appear at a designated depth location in the display field of view to provide a realistic, in-focus three dimensional display of a virtual object which can interact with one or more real objects.

In some embodiments, the image generation unit 1620 includes a microdisplay for projecting images of one or more virtual objects and coupling optics like a lens system for directing images from the microdisplay to a reflecting surface or element 1624. The reflecting surface or element 1624 directs the light from the image generation unit 1620 into a light guide optical element 1612, which directs the light representing the image into the user's eye.

FIG. 24B is a top view of an embodiment of one side of an optical see-through, near-eye, augmented reality display device including a display optical system 1514. A portion of the frame 1515 of the HMD 1502 will surround a display optical system 1514 for providing support and making electrical connections. In order to show the components of the display optical system 1514, in this case 1514r for the right eye system, in HMD 1502, a portion of the frame 1515 surrounding the display optical system is not depicted.

In the illustrated embodiment, the display optical system 1514 is an integrated eye tracking and display system. The system embodiment includes an opacity filter 1517 for enhancing contrast of virtual imagery, which is behind and aligned with optional see-through lens 1616 in this example, light guide optical element 1612 for projecting image data from the image generation unit 1620 is behind and aligned with opacity filter 1517, and optional see-through lens 1618 is behind and aligned with light guide optical element 1612.

Light guide optical element 1612 transmits light from image generation unit 1620 to the eye 1640 of a user wearing HMD 1502. Light guide optical element 1612 also allows light from in front of HMD 1502 to be received through light guide optical element 1612 by eye 1640, as depicted by an arrow representing an optical axis 1542 of the display optical system 1514r, thereby allowing a user to have an actual direct view of the space in front of HMD 1502 in addition to receiving a virtual image from image generation unit 1620. Thus, the walls of light guide optical element 1612 are see-through. In this embodiment, light guide optical element 1612 is a planar waveguide. A representative reflecting element 1634E represents the one or more optical elements like mirrors, gratings, and other optical elements which direct visible light representing an image from the planar waveguide towards the user eye 1640.

Infrared illumination and reflections, also traverse the planar waveguide for an eye tracking system 1634 for tracking the position and movement of the user's eye, typically the user's pupil. Eye movements may also include blinks. The tracked eye data may be used for applications such as gaze detection, blink command detection and gathering biometric information indicating a personal state of being for the user. The eye tracking system 1634 comprises an eye tracking IR illumination source 1634A (an infrared light emitting diode (LED) or a laser (e.g. VCSEL)) and an eye tracking IR sensor 1634B (e.g. IR camera, arrangement of IR photodetectors, or an IR position sensitive detector (PSD) for tracking glint positions). In this embodiment, representative reflecting element 1634E also implements bidirectional infrared (IR) filtering which directs IR illumination towards the eye 1640, preferably centered about the optical axis 1542 and receives IR reflections from the user eye 1640. A wavelength selective filter 1634C passes through visible spectrum light from the reflecting surface or element 1624 and directs the infrared wavelength illumination from the eye tracking illumination source 1634A into the planar waveguide. Wavelength selective filter 1634D passes the visible light and the infrared illumination in an optical path direction heading towards the nose bridge 1504. Wavelength selective filter 1634D directs infrared radiation from the waveguide including infrared reflections of the user eye 1640, preferably including reflections captured about the optical axis 1542, out of the light guide optical element 1612 embodied as a waveguide to the IR sensor 1634B.

Opacity filter 1517 selectively blocks natural light from passing through light guide optical element 1612 for enhancing contrast of virtual imagery. The opacity filter assists the image of a virtual object to appear more realistic and represent a full range of colors and intensities. In this embodiment, electrical control circuitry for the opacity filter, not shown, receives instructions from the control circuitry 1536 via electrical connections routed through the frame.

Again, FIGS. 23A and 23B show half of HMD 1502. For the illustrated embodiment, a full HMD 1502 may include another display optical system 1514 and components described herein.

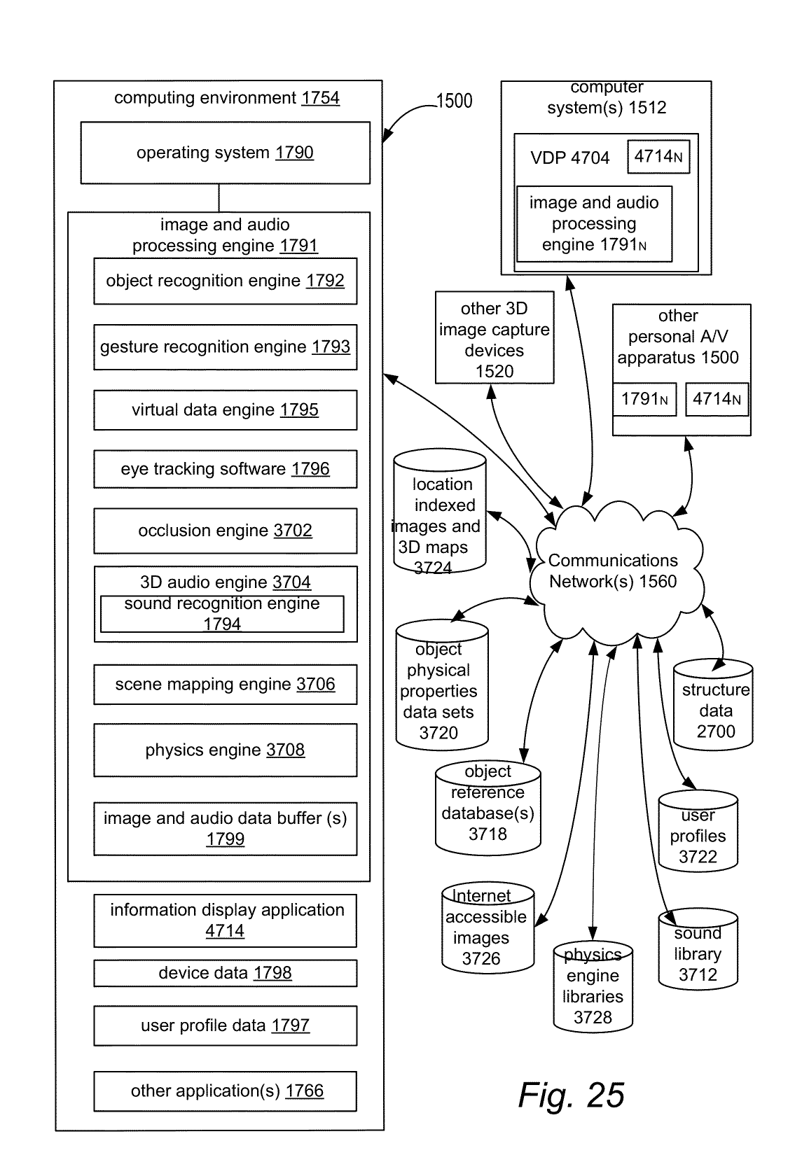

FIG. 25 is a block diagram of a system from a software perspective for representing a physical location at a previous time period with three dimensional (3D) virtual data being displayed by a near-eye, augmented reality display of a personal audiovisual (A/V) apparatus. FIG. 25 illustrates a computing environment embodiment 1754 from a software perspective which may be implemented by a system like physical A/V apparatus 1500, one or more remote computer systems 1512 in communication with one or more physical A/V apparatus or a combination of these. Additionally, physical A/V apparatus can communicate with other physical A/V apparatus for sharing data and processing resources. Network connectivity allows leveraging of available computing resources. An information display application 4714 may be executing on one or more processors of the personal A/V apparatus 1500. In the illustrated embodiment, a virtual data provider system 4704 executing on a remote computer system 1512 can also be executing a version of the information display application 4714 as well as other personal A/V apparatus 1500 with which it is in communication. As shown in the embodiment of Figure will, the software components of a computing environment 1754 comprise an image and audio processing engine 1791 in communication with an operating system 1790. Image and audio processing engine 1791 processes image data (e.g. moving data like video or still), and audio data in order to support applications executing for an HMD system like a physical A/V apparatus 1500 including a near-eye, augmented reality display. Image and audio processing engine 1791 includes object recognition engine 1792, gesture recognition engine 1793, virtual data engine 1795, eye tracking software 1796 if eye tracking is in use, an occlusion engine 3702, a 3D positional audio engine 3704 with a sound recognition engine 1794, a scene mapping engine 3706, and a physics engine 3708 which may communicate with each other.

The computing environment 1754 also stores data in image and audio data buffer(s) 1799. The buffers provide memory for receiving image data captured from the outward facing capture devices 1613, image data captured by other capture devices if available, image data from an eye tracking camera of an eye tracking system 1634 if used, buffers for holding image data of virtual objects to be displayed by the image generation units 1620, and buffers for both input and output audio data like sounds captured from the user via microphone 1510 and sound effects for an application from the 3D audio engine 3704 to be output to the user via audio output devices like earphones 1630.

Image and audio processing engine 1791 processes image data, depth data and audio data received from one or more capture devices which may be available in a location. Image and depth information may come from the outward facing capture devices 1613 captured as the user moves his head or body and additionally from other physical A/V apparatus 1500, other 3D image capture devices 1520 in the location and image data stores like location indexed images and maps 3724.

The individual engines and data stores depicted in FIG. 17 are described in more detail below, but first an overview of the data and functions they provide as a supporting platform is described from the perspective of an application like an information display application 4714 which provides virtual data associated with a physical location. An information display application 4714 executing in the near-eye, augmented reality physical A/V apparatus 1500 or executing remotely on a computer system 1512 for the physical A/V apparatus 1500 leverages the various engines of the image and audio processing engine 1791 for implementing its one or more functions by sending requests identifying data for processing and receiving notification of data updates. For example, notifications from the scene mapping engine 3706 identify the positions of virtual and real objects at least in the display field of view. The information display application 4714 identifies data to the virtual data engine 1795 for generating the structure and physical properties of an object for display. The information display application 4714 may supply and identify a physics model for each virtual object generated for its application to the physics engine 3708, or the physics engine 3708 may generate a physics model based on an object physical properties data set 3720 for the object.

The operating system 1790 makes available to applications which gestures the gesture recognition engine 1793 has identified, which words or sounds the sound recognition engine 1794 has identified, the positions of objects from the scene mapping engine 3706 as described above, and eye data such as a position of a pupil or an eye movement like a blink sequence detected from the eye tracking software 1796. A sound to be played for the user in accordance with the information display application 4714 can be uploaded to a sound library 3712 and identified to the 3D audio engine 3704 with data identifying from which direction or position to make the sound seem to come from. The device data 1798 makes available to the information display application 4714 location data, head position data, data identifying an orientation with respect to the ground and other data from sensing units of the HMD 1502.

The scene mapping engine 3706 is first described. A 3D mapping of the display field of view of the augmented reality display can be determined by the scene mapping engine 3706 based on captured image data and depth data, either derived from the captured image data or captured as well. The 3D mapping includes 3D space positions or position volumes for objects.

A depth map representing captured image data and depth data from outward facing capture devices 1613 can be used as a 3D mapping of a display field of view of a near-eye augmented reality display. A view dependent coordinate system may be used for the mapping of the display field of view approximating a user perspective. The captured data may be time tracked based on capture time for tracking motion of real objects. Virtual objects can be inserted into the depth map under control of an application like information display application 4714. Mapping what is around the user in the user's environment can be aided with sensor data. Data from an orientation sensing unit 1632, e.g. a three axis accelerometer and a three axis magnetometer, determines position changes of the user's head and correlation of those head position changes with changes in the image and depth data from the front facing capture devices 1613 can identify positions of objects relative to one another and at what subset of an environment or location a user is looking.

In some embodiments, a scene mapping engine 3706 executing on one or more network accessible computer systems 1512 updates a centrally stored 3D mapping of a location and apparatus 1500 download updates and determine changes in objects in their respective display fields of views based on the map updates. Image and depth data from multiple perspectives can be received in real time from other 3D image capture devices 1520 under control of one or more network accessible computer systems 1512 or from one or more physical A/V apparatus 1500 in the location. Overlapping subject matter in the depth images taken from multiple perspectives may be correlated based on a view independent coordinate system, and the image content combined for creating the volumetric or 3D mapping of a location (e.g. an x, y, z representation of a room, a store space, or a geofenced area). Additionally, the scene mapping engine 3706 can correlate the received image data based on capture times for the data in order to track changes of objects and lighting and shadow in the location in real time.

The registration and alignment of images allows the scene mapping engine to be able to compare and integrate real-world objects, landmarks, or other features extracted from the different images into a unified 3-D map associated with the real-world location.

When a user enters a location or an environment within a location, the scene mapping engine 3706 may first search for a pre-generated 3D map identifying 3D space positions and identification data of objects stored locally or accessible from another physical A/V apparatus 1500 or a network accessible computer system 1512. The pre-generated map may include stationary objects. The pre-generated map may also include objects moving in real time and current light and shadow conditions if the map is presently being updated by another scene mapping engine 3706 executing on another computer system 1512 or apparatus 1500. For example, a pre-generated map indicating positions, identification data and physical properties of stationary objects in a user's living room derived from image and depth data from previous HMD sessions can be retrieved from memory. Additionally, identification data including physical properties for objects which tend to enter the location can be preloaded for faster recognition. A pre-generated map may also store physics models for objects as discussed below. A pre-generated map may be stored in a network accessible data store like location indexed images and 3D maps 3724.

The location may be identified by location data which may be used as an index to search in location indexed image and pre-generated 3D maps 3724 or in Internet accessible images 3726 for a map or image related data which may be used to generate a map. For example, location data such as GPS data from a GPS transceiver of the location sensing unit 1644 on an HMD 1502 may identify the location of the user. In another example, a relative position of one or more objects in image data from the outward facing capture devices 1613 of the user's physical A/V apparatus 1500 can be determined with respect to one or more GPS tracked objects in the location from which other relative positions of real and virtual objects can be identified. Additionally, an IP address of a WiFi hotspot or cellular station to which the physical A/V apparatus 1500 has a connection can identify a location. Additionally, identifier tokens may be exchanged between physical A/V apparatus 1500 via infra-red, Bluetooth or WUSB. The range of the infra-red, WUSB or Bluetooth signal can act as a predefined distance for determining proximity of another user. Maps and map updates, or at least object identification data may be exchanged between physical A/V apparatus via infra-red, Bluetooth or WUSB as the range of the signal allows.

The scene mapping engine 3706 identifies the position and tracks the movement of real and virtual objects in the volumetric space based on communications with the object recognition engine 1792 of the image and audio processing engine 1791 and one or more executing applications generating virtual objects.

The object recognition engine 1792 of the image and audio processing engine 1791 detects, tracks and identifies real objects in the display field of view and the 3D environment of the user based on captured image data and captured depth data if available or determined depth positions from stereopsis. The object recognition engine 1792 distinguishes real objects from each other by marking object boundaries and comparing the object boundaries with structural data. One example of marking object boundaries is detecting edges within detected or derived depth data and image data and connecting the edges. Besides identifying the type of object, an orientation of an identified object may be detected based on the comparison with stored structure data 2700, object reference data sets 3718 or both. One or more databases of structure data 2700 accessible over one or more communication networks 1560 may include structural information about objects. As in other image processing applications, a person can be a type of object, so an example of structure data is a stored skeletal model of a human which may be referenced to help recognize body parts. Structure data 2700 may also include structural information regarding one or more inanimate objects in order to help recognize the one or more inanimate objects, some examples of which are furniture, sporting equipment, automobiles and the like.

The structure data 2700 may store structural information as image data or use image data as references for pattern recognition. The image data may also be used for facial recognition. The object recognition engine 1792 may also perform facial and pattern recognition on image data of the objects based on stored image data from other sources as well like user profile data 1797 of the user, other users profile data 3722 which are permission and network accessible, location indexed images and 3D maps 3724 and Internet accessible images 3726.

FIG. 26 is a block diagram of one embodiment of a computing system that can be used to implement one or more network accessible computer systems 1512 or a companion processing module 1504 which may host at least some of the software components of computing environment 1754 or other elements depicted in FIG. 17. With reference to FIG. 26, an exemplary system includes a computing device, such as computing device 1800. In its most basic configuration, computing device 1800 typically includes one or more processing units 1802 including one or more central processing units (CPU) and one or more graphics processing units (GPU). Computing device 1800 also includes system memory 1804. Depending on the exact configuration and type of computing device, system memory 1804 may include volatile memory 1805 (such as RAM), non-volatile memory 1807 (such as ROM, flash memory, etc.) or some combination of the two. This most basic configuration is illustrated in FIG. 26 by dashed line 1806. Additionally, device 1800 may also have additional features/functionality. For example, device 1800 may also include additional storage (removable and/or non-removable) including, but not limited to, magnetic or optical disks or tape. Such additional storage is illustrated in FIG. 18 by removable storage 1808 and non-removable storage 1810.

Device 1800 may also contain communications connection(s) 1812 such as one or more network interfaces and transceivers that allow the device to communicate with other devices. Device 1800 may also have input device(s) 1814 such as keyboard, mouse, pen, voice input device, touch input device, etc. Output device(s) 1816 such as a display, speakers, printer, etc. may also be included. These devices are well known in the art so they are not discussed at length here.

While temple arms providing a long axis compression in a A/R HMD is described herein, one of ordinary skill in the art would understand that temple arms as described herein may also be used in a V/R HMD embodiment as well.

Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

We claim:

1. A temple arm for a head mounted display, the temple arm including a first end proximal optics for the head mounted display and a second end opposite the first end, the arm comprising:
a band extending at least partially between the first and second ends;
a spring extending at least partially between the first and second ends, the spring and band affixed together at the first and second ends and the spring being longer than the band and flexed away from the band in one of a first direction and a second direction, the band being substantially straight when the spring is flexed into the first direction, and the band bending when the spring is flexed into the second direction.

2. The temple arm of claim 1, the band comprising a first band, the temple arm further comprising a second band affixed to the first band and the spring at the first and second ends of the temple arm, the second band being substantially straight when the spring is flexed into the first direction, and the band bending when the spring is flexed into the second direction.

3. The temple arm of claim 2, wherein the first and second bands are coplanar when the spring is flexed in the first direction, and bent in the same way when the spring is in the second direction.

4. The temple arm of claim 1, wherein the spring is configured to flex from the first direction to the second direction by a force exerted on the spring by a head of a wearer upon the wearer putting on the head mounted display.

5. The temple arm of claim 4, wherein the distal end of the temple arm wraps around a portion of the wearer's head when the band bends upon the spring flexing to the second direction.

6. The temple arm of claim 5, wherein a portion of the band that flexes is positioned adjacent the first end of the temple arm so that the spring does not engage the wearer's end until the band is in position to wrap around the portion of the wearer's head.

7. The temple arm of claim 1, further comprising an interface material extending at least partially between the first and second ends, and at least partially encasing the band and spring, the interface material provided for comfort.

8. The temple arm of claim 1, wherein the optics of the head mounted display are capable of displaying virtual images to the optics to create a virtual or augmented reality environment.

9. A temple arm for a head mounted display, the temple arm including a first end proximal optics for the head mounted display and a second end opposite the first end, the arm comprising:
a plurality of arm sections; and
a plurality of spring joints between and affixing the arm sections, a spring joint including a spring and one or more fasteners for affixing the spring joint between adjacent arm sections of the plurality of arm sections, the spring biasing the adjacent arm sections to fold toward each other, the adjacent arm sections including ends which come together to limit folding of the adjacent arm sections with respect to each other.

10. The temple arm of claim 9, wherein folding of adjacent arm sections in the plurality of arm sections under bias of the springs of the plurality of spring joints wraps the temple arm at least partially around a head of a wearer to support the head mounted display on the head of the wearer.

11. The temple arm of claim 10, wherein forces exerted by different arm sections on different portions of the head of the wearer are controlled by controlling spring constants of the plurality of springs of the spring joints.

12. The temple arm of claim 11, wherein a spring constant for a spring adjacent the second end of the temple arm is larger than a spring constant for a spring positioned closer to the first end of the temple arm.

13. The temple arm of claim 9, wherein the plurality of arm sections comprise at least four arm sections and the plurality of spring joints comprise at least three spring joints.

14. The temple arm of claim 9, wherein at least one of the arm sections has an adjustable length.

15. The temple arm of claim 9, wherein the optics of the head mounted display are capable of displaying virtual images to the optics to create a virtual or augmented reality environment.

16. A method of supporting a head mounted display on a head of a wearer, the head mounted display including optics, the method comprising:
(a) configuring a pair of temple arms affixed to the optics to maintain a first shape enabling the temple arms to be positioned on opposite temples of a wearer;
(b) configuring the pair of temple arms to maintain a second shape where each temple arm includes at least a portion distal from the optics that wrap partially around a head of the wearer; and
(c) providing a mechanism for moving the pair of temple arms from the first shape to the second shape when the head mounted display is worn by the user.

17. The method of claim 16, said step (c) comprising the steps of:
providing first and second layers to each of the temple arms, the first and second layers affixed to each other, and
changing a length of the first layer with respect to the second layer.

18. The method of claim 17, said step of changing a length of the first layer with respect to the second layer comprising the steps of threading a cord through the first layer and shortening a length of the cord.

19. The method of claim 16, said step (c) comprising the step of providing each temple arm with a band and a spring affixed to each other at opposed ends, the spring being longer than the band and flexed away from the band in one of a first direction and a second direction, the band being substantially straight when the spring is flexed into the first direction, and the band bending when the spring is flexed into the second direction.

20. The method of claim 16, said step (c) comprising the step of providing each temple arm with a plurality of arm sections, and a plurality of spring joints between and affixing the arm sections, a spring joint including a spring and one or more fasteners for affixing the spring joint between adjacent arm sections of the plurality of arm sections, the spring biasing the adjacent arm sections to fold toward each other, the wearer holding the arm sections in the first shape and the spring joints moving the arm sections to the second shape around the wearer's head when the wearer releases the arm sections.
